(19) United States
(12) Patent Application Publication
(10) Pub. No.: US 2010/0149375 A1
(43) Pub. Date: Jun. 17, 2010

(54) APPARATUS AND METHOD FOR FASTER RECORDING AND REPRODUCTION OF DIGITAL VIDEO IMAGES

(75) Inventor: Naozumi Sugimura, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/358,403

(22) Filed: Jan. 23, 2009

(30) Foreign Application Priority Data
Dec. 12, 2008 (KR) 10-2008-0126536

(51) Int. Cl. H04N 5/76; H04N 7/26

(52) U.S. Cl. 348/231.2; 386/124; 348/E05.031; 386/E05.007

(57) ABSTRACT

The present invention provides a faster method and apparatus for recording and reproduction of a digital movie. The photographing apparatus includes both a recording unit and a reproducing unit for playback. Digital image data is produced by an imaging device as a sequence of frames. Because parameters (such as luminance and chrominance) that describe each frame are calculated and stored while the frames are being recorded, the parameters may be read upon playback by the reproducing unit of the present invention, thereby eliminating the need for redundant image processing.

### CROSS-REFERENCE TO RELATED PATENT APPLICATION

This application claims the benefit of Korean Patent Application No. 10-2008-0126536, filed on Dec. 12, 2008, in the Korean Intellectual Property Office, the disclosure of which is incorporated herein in its entirety by reference.

### BACKGROUND OF THE INVENTION

1. Field of the Invention

The present invention relates to digital image processing. More specifically, the present invention relates to an apparatus and method for faster processing, recording, and reproduction of digital images captured in a sequence of frames.

2. Description of the Related Art

A photographing apparatus that can record a moving picture, such as a video camera or a camcorder, generally performs predetermined image processing on a signal output from an imaging device, such as a charge coupled device (CCD). For example, the photographing apparatus typically compresses the signal in accordance with a standard, such as the Moving Picture Experts Group (MPEG)-2 standard, and records the signal on a recording medium, such as flash memory, a hard disk (HDD), or a digital versatile disk (DVD).

Typically, image processing includes white balance control and exposure control. Thus, there is known a method of recording image data of a still image obtained from a moving picture, and white balance data obtained by performing image processing, onto an image file.

Image processing may also include compressing of the digital image data. Generally, as an image is compressed, recording and reproduction quality of the image deteriorates in comparison to raw image data that is not compressed. Thus, a photographing apparatus that records still image data, such as a digital camera, often will directly record a signal output from an imaging device in a raw format without compressing the signal.

In the past, image signals have been selectively recorded in either a compression format such as a Joint Photographic Experts Group (JPEG) format or in a raw format for directly recording the image signal. But when a signal output from an imaging device is directly recorded on a recording medium, although image quality is preserved, the amount of data that needs to be stored is increased. Thus, a moving picture, which requires many images to be stored, is typically not recorded in raw format.

Moreover, image data recorded in a raw format requires additional processing. Typically, when a still image is displayed, image data recorded in the raw format is read and a parameter appropriate to display the still image is calculated. Image processing is next performed on the still image by using the calculated parameter. Finally, the processed still image is displayed. The parameter calculated is, for example, a white balance correction value for controlling white balance, or a luminance correction value for correcting luminance.

By contrast to the recording and display of a still picture, in order to reproduce a moving picture by using a signal that is directly recorded from an imaging device, image processing has to be continuously performed at high speed. Too much time is required to perform a series of processes including reading image data; calculating a parameter; and performing image processing by using the parameter, on each frame of the moving picture as in a still image. Thus, the moving picture cannot be reproduced at high quality.

### SUMMARY OF THE INVENTION

The present invention provides a photographing apparatus, which includes both a recording unit and a reproducing unit for playback. Digital image data is produced by an imaging device as a sequence of frames. Because parameters (such as luminance and chrominance) that describe each frame are calculated and stored while the frames are being recorded, the parameters may be read upon playback by the reproducing unit of the present invention, thereby eliminating the need for redundant image processing.

According to an aspect of the present invention, the recording unit includes a parameter calculator and a recording medium. The parameter calculator receives digital image data output in a sequence of frames from an imaging device and generates at least one parameter for each frame in the sequence of frames. In an embodiment, both chrominance and luminance parameters are calculated. The recording medium then receives and stores in a parameter file the one or more parameters calculated.

The reproducing unit of the present invention includes a data reader, a parameter file processor, and an image processor. The data reader recovers the parameter file from a storage medium, and supplies the parameter file to a parameter file processor, which uses the parameter file to reproduce the one or more parameters stored by the recording unit. In another embodiment, however, the parameters reproduced by the parameter file processor may be generated from a combination of several of the parameters stored by the recording unit. The image processor is provided by the present invention to process digital image data and display a sequence of frames of digital image data in accordance with the one or more parameters reproduced by the parameter file processor.

According to another aspect of the present invention, the recording unit includes a parameter calculator as a means for calculating at least one parameter for each frame in a sequence of frames of digital image data output by an imaging device. In such an embodiment, the recording medium is also provided as a means for storing in a parameter file the at least one parameter that corresponds to each frame in the sequence of frames.

The photographing apparatus described in summary above is also associated with a method of using the photographing apparatus in another aspect of the present invention. The method includes steps of calculating the one or more parameters associated with each frame in a sequence of frames of digital image data. These one or more parameters are then stored in a parameter file in accordance with the method of the present invention, which is then read back and reprocessed to reproduce images without the need for redundant processing of the frames.

In various embodiments of the apparatus and method of the present invention, the one or more parameters may include luminance, chrominance, chromatic aberration, or some combination of one or all of the above.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a recording apparatus according to an embodiment of the present invention;

FIG. 2 is a block diagram of a reproducing apparatus according to an embodiment of the present invention;

FIG. 3 is a structural diagram of a data file and a parameter file, according to an embodiment of the present invention;

FIG. 4 is a flowchart of a method of generating a parameter file by using a recording apparatus, according to an embodiment of the present invention;

FIG. 5 is a flowchart of a method of generating a data file by using a recording apparatus, according to an embodiment of the present invention; and

FIG. 6 is a flowchart of a method of reproducing audio/video (AV) data by using a reproducing apparatus, according to an embodiment of the present invention.

### DETAILED DESCRIPTION OF THE INVENTION

Hereinafter, the present invention will be described in detail by explaining embodiments of the invention with reference to the attached drawings. Like reference numerals in the drawings denote like elements, and thus repeated descriptions will be omitted.

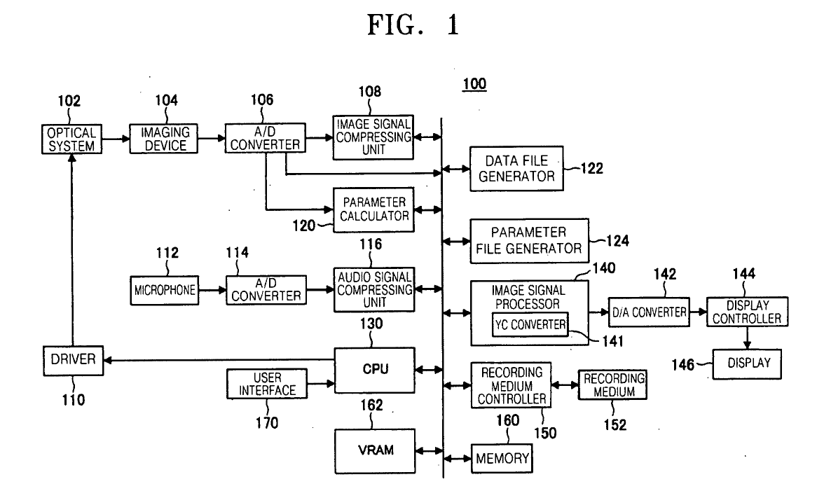

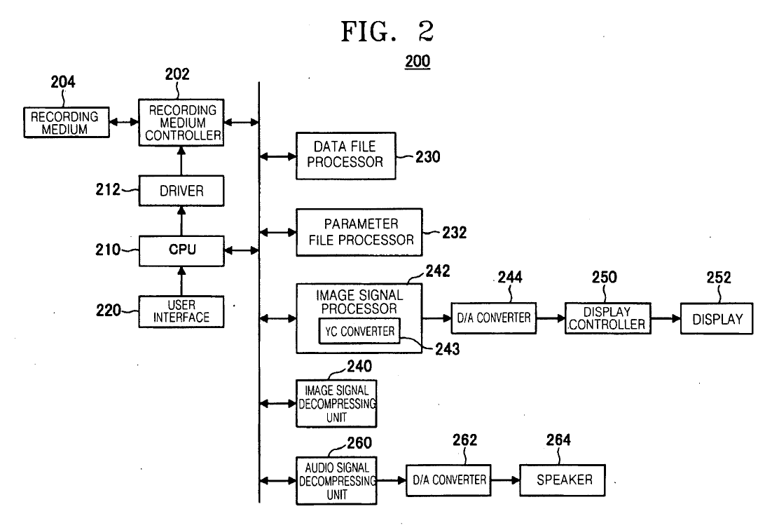

A photographing apparatus according to an embodiment of the present invention will now be described. The photographing apparatus according to the current embodiment includes a recording apparatus (recording unit) for recording audio/video (AV) data and a reproducing apparatus (reproducing unit) for reproducing the AV data. The recording apparatus and the reproducing apparatus may be integrally or independently formed. The recording apparatus and the reproducing apparatus will now be described in detail with reference to FIGS. 1 and 2.

FIG. 1 is a block diagram of a recording apparatus 100 according to an embodiment of the present invention.

Referring to FIG. 1, the recording apparatus 100 may be, for example, a video camera or a camcorder, which generates AV data by using an imaging device and an optical system, and records the AV data.

The recording apparatus 100 may include an optical system 102, a driver 110, an imaging device 104, a microphone 112, analog-to-digital (A/D) converters 106 and 114, an image signal compressing unit 108, an audio signal compressing unit 116, a parameter calculator 120, a data file generator 122, a parameter file generator 124, a central processing unit (CPU) 130, an image signal processor 140, a digital-to-analog (D/A) converter 142, a display controller 144, a display 146, a recording medium controller 150, a recording medium 152, a memory 160, a video random access memory (VRAM) 162, and a user interface 170.

Although not shown in detail, the optical system 102 may include a focus lens, a zoom lens, and an iris. The optical system 102 transmits an image of a subject and forms an image of the subject on the imaging device 104. The focus lens focuses the image of the subject on the imaging device 104, the zoom lens varies a focal length, and the iris varies an amount of light to be incident on the imaging device 104.

The driver 110 drives the focus lens, the zoom lens, and the iris of the optical system 102 in accordance with focus control and exposure control performed by the CPU 130.

The imaging device 104 is an image sensor such as a charge coupled device (CCD) or a complementary metal-oxide semiconductor (CMOS), and performs photoelectric conversion of the image formed on the imaging device 104 so as to output an electrical signal (image signal) in frames.

The A/D converter 106 converts the electrical signal output from the imaging device 104, into digital data (image data in a raw format). Here, a correlated double sampling (CDS) circuit or an amplifier circuit may be include between the imaging device 104 and the A/D converter 106 so as to remove noise from or amplify the electrical signal output from the imaging device 104.

The A/D converter 106 outputs the image data to the image signal compressing unit 108 and the parameter calculator 120 in sequential frames. The image data output from the A/D converter 106 is processed in a raw format without performing image processing such as white balance control or exposure control, or irreversible compression such as Joint Photographic Experts Group (JPEG) compression.

The image signal compressing unit 108 compresses the image data output from the A/D converter 106 by performing reversible compression on the image data, and outputs the compressed image data to the data file generator 122. Due to the reversible compression, the number of bytes of image data may be reduced and the image data may be recorded and reproduced without deterioration of image quality. The reversible compression includes, for example, entropy coding using Huffman codes. Also the compression need not be limited to a reversible process.

The microphone 112 is an example of an audio input unit. The microphone 112 receives sound from outside the recording apparatus 100, converts the sound into an electrical signal, and outputs the electrical signal to the A/D converter 114.

The A/D converter 114 converts the electrical signal output from the microphone 112 into audio digital data (audio data), and outputs the audio data to the audio signal compressing unit 116.

The audio signal compressing unit 116 compresses the audio data output from the A/D converter 114 and outputs the compressed audio data to the data file generator 122. Here, the audio signal compressing unit 116 may compress the audio data in accordance with the MPEG-1 Audio Layer 3 (MP3) standard or the Advanced Audio Coding (AAC) standard.

The parameter calculator 120 calculates parameters required to perform image processing in frames, in order to reproduce the image data output in a raw format from the A/D converter 106. Here, a parameter is, for example, a white balance correction value for controlling white balance, or an exposure correction value for controlling exposure. The parameter calculator 120 may calculate the parameters while the image data is being recorded, or after the image data is recorded and in accordance with the recorded image data. The parameters calculated by the parameter calculator 120 are output to the parameter file generator 124.

The data file generator 122 generates a data file by using the image data output from the image signal compressing unit 108 and the audio data output from the audio signal compressing unit 116, and outputs the data file to the recording medium controller 150. The data file is recorded on the recording medium 152.

The parameter file generator 124 generates a parameter file by using the parameters calculated by the parameter calculator 120, which in turn are extracted from the image data of a plurality of frames, and outputs the parameter file to the recording medium controller 150. The parameter file is recorded on the recording medium 152.

The CPU 130 functions as an operation processor and a controller by using a program, and may control each element of the recording apparatus 100.

For example, the CPU 130 drives the optical system 102 by outputting a signal to the driver 110 in order to perform focus control or exposure control. Also, the CPU 130 controls each element of the recording apparatus 100 in accordance with a signal from the user interface 170.

Although a single CPU is illustrated in FIG. 1 as the CPU 130, the CPU 130 may include a plurality of CPUs which separately control each element of the recording apparatus 100.

The image signal processor 140 performs image processing required when the display 146 reproduces live-view image data in frames, on the image data output from the A/D converter 106. For example, white balance control and exposure control are performed on the image data by the image signal processor 140.

The image signal processor 140 includes a YC converter 141. The YC converter 141 performs luminance/chrominance (YC) conversion on the image data which has the raw format and is directly output from the imaging device 104 through the A/D converter 106.

The YC converter 141 may obtain a luminance signal and a chrominance signal by performing the YC conversion on the image data. As the luminance and chrominance signals are obtained by performing the YC conversion, the display 146 may display an image. The luminance and chrominance signals obtained by the image signal processor 140 are output to the D/A converter 142.

The D/A converter 142 converts the luminance and chrominance signals which are output from the image signal processor 140 and are digital signals, into an analog signal, and outputs the analog signal to the display controller 144.

The display controller 144 drives the display 146 and controls an output of the display 146. For example, the display 146 includes a display means such as a liquid crystal display (LCD) device. The display 146 displays live-view images read from the VRAM 162 before performing a photographing manipulation, windows for setting various functions of the recording apparatus 100, or captured and recorded images.

The recording medium controller 150 is an example of a medium recorder, and controls image data to be recorded on the recording medium 152, or controls image data and setting information which are recorded on the recording medium 152, to be read.

The recording medium 152 is, for example, an optical recording medium (a compact disk (CD), a digital versatile disk (DVD), etc.), an optical magnetic disk, a magnetic disk, or a semiconductor memory medium, and records captured image data. The recording medium controller 150 and the recording medium 152 may be detachable from the recording apparatus 100.

The memory 160 is a semiconductor memory device such as a synchronous dynamic random access memory (SDRAM), and temporarily stores captured images. The memory 160 has a memory capacity that is sufficient to store the image data of a plurality of frames. Also, a program for operating the CPU 130 is stored in the memory 160.

The VRAM 162 is a memory device for displaying images, and includes a plurality of channels so that an image is displayed on the display 146 and the displayed image is recorded at the same time. The VRAM 162 temporarily stores an image signal when the display 146 displays a live-view image in a recording mode or displays an image in a reproducing mode.

Although not shown in detail, the user interface 170 includes a power switch, a mode change means, a recording start button, a recording stop button, etc., and is used to operate or set various functions of the recording apparatus 100. The recording start button and the recording stop button are buttons for photographing manipulation.

FIG. 2 is a block diagram of a reproducing apparatus 200 according to an embodiment of the present invention. FIG. 2 will be described in conjunction with FIG. 1.

Referring to FIG. 2, the reproducing apparatus 200 may reproduce image data and audio data by using a data file and a parameter file which are recorded by the recording apparatus 100.

The reproducing apparatus 200 may include a recording medium controller 202, a recording medium 204, a CPU 210, a driver 212, a user interface 220, a data file processor 230, a parameter file processor 232, an image signal decompressing unit 240, an audio signal decompressing unit 260, an image signal processor 242, D/A converters 244 and 262, a display controller 250, a display 252, and a speaker 264.

The recording medium controller 202 is an example of a data reader, and controls image data and setting information which are recorded on the recording medium 204, to be read.

The recording medium 204 is, for example, an optical recording medium (a CD, a DVD, etc.), an optical magnetic disk, a magnetic disk, or a semiconductor memory medium, and records captured image data and audio data.

The recording medium controller 202 and the recording medium 204 may be detachable from the reproducing apparatus 200.

If the data file and the parameter file, which are generated and recorded by the recording apparatus 100, are recorded on the recording medium 204, the recording medium controller 202 reads the data file and the parameter file. Then, the data file is output to the data file processor 230 and the parameter file is output to the parameter file processor 232.

The CPU 210 functions as an operation processor and a controller by using a program, and may control each element of the reproducing apparatus 200.

For example, the CPU 210 drives the recording medium controller 202 by outputting a signal to the driver 212 in accordance with a manipulation of the user interface 220. Also, the CPU 210 controls each element of the reproducing apparatus 200 in accordance with a signal of the user interface 220. Although a single CPU is illustrated in FIG. 2 as the CPU 210, the CPU 210 may include a plurality of CPUs which separately control each element of the reproducing apparatus 200.

The driver 212 drives the recording medium controller 202 in accordance with, for example, reproduction control performed on the recording medium 204 by the CPU 210.

Although not shown in detail, the user interface 220 includes a power switch, a reproduction start button, various setting keys, etc., and is used to operate or set various functions of the reproducing apparatus 200 by a user. For example, the reproduction start button is a button for starting reproduction of image data.

The data file processor 230 divides the data file output from the recording medium controller 202, into compressed audio data and compressed image data, and outputs the compressed image data to the image signal decompressing unit 240 and the compressed audio data to the audio signal decompressing unit 260.

The parameter file processor 232 obtains parameters from the parameter file output from the recording medium controller 202, and outputs the parameters to the image signal processor 242.

The image signal decompressing unit 240 obtains the compressed image data output from the data file processor 230. If reversible compression is performed on the compressed image data by the image signal compressing unit 108 of the recording apparatus 100, the image signal decompressing unit 240 decompresses the compressed image data and obtains original image data. The original image data is identical to the image data which is output from the A/D converter 106 of the recording apparatus 100 and on which the reversible compression is not performed. The image signal decompressing unit 240 outputs the image data to the image signal processor 242.

The image signal processor 242 is an example of an image processor, and performs image processing required for reproduction, on the image data of each frame output from the image signal decompressing unit 240 in accordance with the parameters output from the parameter file processor 232. For example, white balance control and exposure control are performed on the image data.

The image signal processor 242 includes a YC converter 243. If the image data is directly output from the imaging device 104 through the A/D converter 106 in a raw format, the YC converter 243 performs YC conversion on the image data in the raw format.

The YC converter 243 may obtain a luminance signal and a chrominance signal by performing the YC conversion on the image data. Although the image data in the raw format cannot be displayed by the display 252 such as a monitor, as the luminance and chrominance signals are obtained by performing the YC conversion, the display 252 may display an image. The luminance and chrominance signals obtained by the image signal processor 242 are output to the D/A converter 244.

The D/A converter 244 converts the luminance and chrominance signals which are output from the image signal processor 242 and are digital signals, into an analog signal, and outputs the analog signal to the display controller 250.

The display controller 250 drives the display 252 and controls an output of the display 252.

For example, the display 252 includes a display means such as an LCD device. The display 252 displays windows for setting various functions of the reproducing apparatus 200, or images read from the recording medium 204.

Although the display controller 250 and the display 252 are included in the reproducing apparatus 200 in FIG. 2, the present invention is not limited thereto. For example, an image signal output from the D/A converter 244 may be displayed on an external display device such as a television monitor.

The audio signal decompressing unit 260 receives the compressed audio data output from the data file processor 230. Then, the audio signal decompressing unit 260 decompresses the compressed audio data, obtains an audio signal, and outputs the audio signal to the D/A converter 262.

The D/A converter 262 convert the audio signal output from the audio signal decompressing unit 260, into an analog signal. The D/A converter 262 output the analog signal to the speaker 264.

The speaker 264 outputs sound in accordance with the analog signal output from the D/A converter 262.

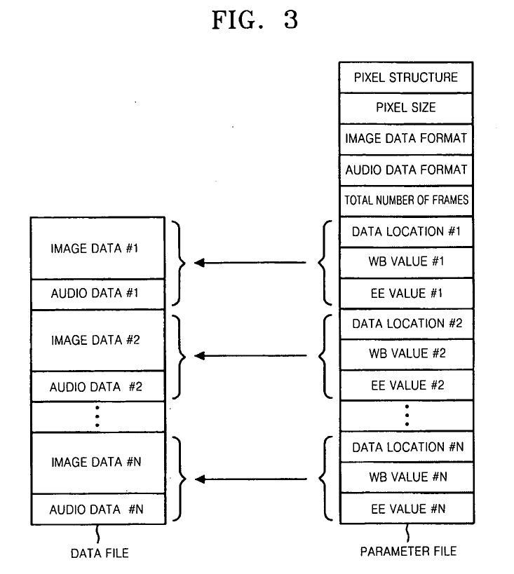

Structures of a data file and a parameter file will now be described with reference to FIG. 3.

FIG. 3 is a structural diagram of a data file and a parameter file, according to an embodiment of the present invention.

Referring to FIG. 3, the data file is formed by alternately repeating image data of a frame and audio data of the frame corresponding to the image data. In other words, the data file is formed by corresponding image data and audio data to each other one-to-one with respect to each frame and arranging a plurality of frames in a time-series order. For example, if N frames exist from a first frame to an Nth frame, the N frames are arranged as illustrated in FIG. 3.

As such, each frame includes the image data and the audio data and thus the data file may be cut or connected in frames. Also, according to the current embodiment of the present invention, the image data is raw image data that is not compressed in a direction of a time axis. Thus, according to the current embodiment of the present invention, image editing may be easily performed in frames.

Various parameters regarding the image data and the audio data are recorded in the parameter file. The parameter file records basic information of the image data, such as a pixel structure, a pixel size, a compression format, and a total number of frames, and basic information of the audio data, such as the number of bits, a sampling frequency, the number of samples, and a data compression format of the audio data.

The parameter file records byte locations of the frames of the data file including the image data and the audio data and also records parameters which are calculated by the parameter calculator 120 illustrated in FIG. 1 and are required to perform image processing on the frames. In FIG. 3, a white balance (WB) value and an exposure (EE) value are shown as an example of a parameter and the parameter file is formed by arranging data locations, white balance (WB) values, and exposure (EE) values in frames in a time-series order.

Since the parameter file is generated and recorded before the data file is reproduced, the parameter file may be read when the data file is reproduced and thus various parameters for white balance control or exposure control may not be re-calculated. Accordingly, the data file may be fast and easily reproduced.

Also, since the parameter file may be independently read regardless of the data file, the parameter file processor 232 illustrated in FIG. 2 may set at least one designated value to parameters corresponding to raw image data of a plurality of frames in a series of desired scenes. For example, when a series of scenes are reproduced, in order to suppress variations in white balance correction or luminance correction, calculation for equalizing parameter variations may be performed in advance. As a result, distribution of color or luminance may be suppressed during reproducing the series of scenes, thereby allowing smooth reproduction.

A method of generating a parameter file by using a recording apparatus will now be described.

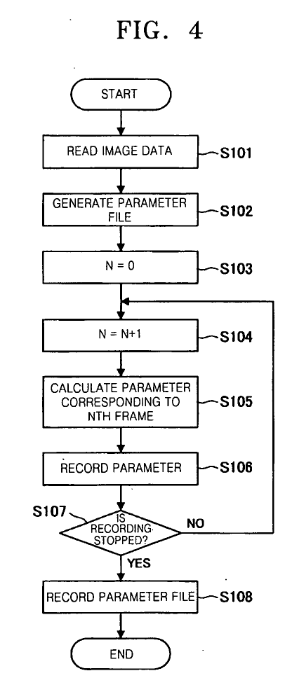

FIG. 4 is a flowchart of a method of generating a parameter file by using the recording apparatus 100 illustrated in FIG. 1, according to an embodiment of the present invention. FIG. 4 will be described in conjunction with FIG. 1.

Referring to FIG. 4, initially, the parameter calculator 120 reads image data through the A/D converter 106 in operation S101.

The parameter file generator 124 generates an initialized parameter file in order to record parameters therein, in operation S102. In this case, the parameter file records basic information of the image data, such as a pixel structure, a pixel size, a compression format, and a total number of frames, and basic information of audio data, such as the number of bits, a sampling frequency, the number of samples, and a data compression format of the audio data.

The parameter calculator 120 sequentially calculates parameters required to perform image processing on the image data in frames from a first frame that is an initial recorded frame, in operations S103 through S107.

For example, initially, N=0 is set in operation S103, and then, N=N+1 is calculated in operation S104. Since N=1 at first, a parameter corresponding to the first frame is calculated in operation S105. Then, the calculated parameter corresponding to the first frame is recorded as data of the parameter file in operation S106. Then, it is determined whether recording is stopped, in operation S107. For example, operations S104 through S107 are repeated until a user presses a recording stop button so as to stop the recording.

If the recording is stopped, the parameter file in which the basic information of the image data and the audio data, and parameters corresponding to N frames from the first frame to an Nth frame that is a last recorded frame, are recorded is completely generated and the generated parameter file is recorded on, for example, the recording medium 152, in operation S108. The parameter file may be generated while the image data and the audio data are being recorded or after the image data and the audio data are recorded.

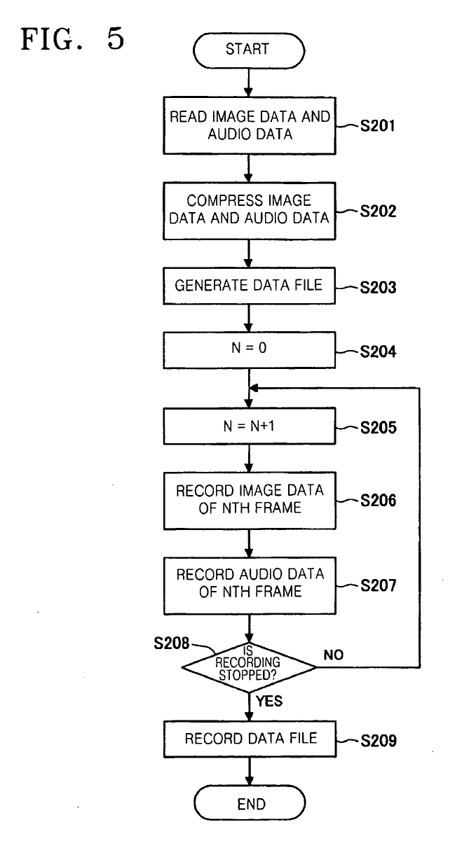

A method of generating a data file by using a recording apparatus will now be described with reference to FIG. 5.

FIG. 5 is a flowchart of a method of generating a data file by using the recording apparatus 100 illustrated in FIG. 1, according to an embodiment of the present invention. FIG. 5 will be described in conjunction with FIG. 1. Referring to FIG. 5, initially, the recording apparatus 100 reads image data by using the imaging device 104 and read audio data by using the microphone 112, in operation S201.

Then, the image signal compressing unit 108 compresses the image data and the audio signal compressing unit 116 compresses the audio data, in operation S202.

Also, the data file generator 122 generates an initialized data file in order to record the image data and the audio data therein, in operation S203

Then, the data file generator 122 sequentially records a plurality of frames of the image data and the audio data as data of the data file, in operations S204 through S208.

For example, initially, N=0 is set in operation S204, and then, N=N+1 is calculated in operation S205. Since N=1 at first, the image data of the first frame is recorded in operation S206, and the audio data of the first frame, which correspond to the image data of the first frame, is recorded in operation S207. Then, it is determined whether recording is stopped, in operation S208. For example, operations S205 through S208 are repeated until a user presses a recording stop button so as to stop the recording.

If the recording is stopped, the data file in which the image data and the audio data of N frames from the first frame to an Nth frame that is a last recorded frame, are recorded is completely generated and the generated data file is recorded on, for example, the recording medium 152, in operation S209.

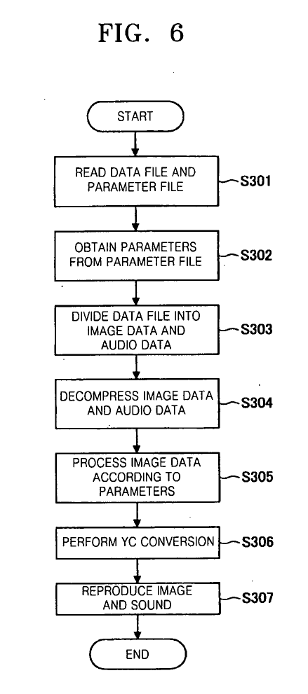

A method of reproducing AV data by using a reproducing apparatus will now be described with reference to FIG. 6.

FIG. 6 is a flowchart of a method of reproducing AV data by using the reproducing apparatus 200 illustrated in FIG. 2, according to an embodiment of the present invention. FIG. 6 will be described in conjunction with FIG. 2.

Referring to FIG. 6, initially, the recording medium controller 202 reads a data file and a parameter file which are recorded on the recording medium 204, in operation S301.

Also, the parameter file processor 232 receives the parameter file and obtains parameters from the parameter file, in operation S302. Then, the parameter file processor 232 outputs the parameters to the image signal processor 242.

Then, the data file processor 230 obtains the data file and divides the data file into compressed image data and compressed audio data, in operation S303.

The data file processor 230 outputs the compressed image data to the image signal decompressing unit 240 and outputs the compressed audio data to the audio signal decompressing unit 260.

Also, the image signal decompressing unit 240 decompresses the compressed image data and the audio signal decompressing unit 260 decompresses the compressed audio data, in operation S304. The decompressed image data is output to the image signal processor 242 and the decompressed audio data is output to the D/A converter 262.

Then, the image signal processor 242 obtains the decompressed image data from the image signal decompressing unit 240, obtains the parameters from the parameter file processor 232, and performs image processing on the decompressed image data in frames in accordance with the parameters, in operation S305.

Also, the YC converter 243 of the image signal processor 242 converts the decompressed image data into an image signal including a luminance signal and a chrominance signal in operation S306.

Then the image signal is output to the display controller 250 through the D/A converter 244 and the display 252 displays an image. Also, the D/A converter 262 converts the audio data into an analog audio signal and outputs the analog audio signal to the speaker 264. The speaker 264 outputs sound in correspondence to the image displayed by the display 252, in operation S307.

According to the above embodiments of the present invention, the recording apparatus 100 previously calculates parameters required to perform image processing in frames, in order to reproduce image data. Also, the parameters are recorded in a parameter file regardless of a data file including image data and audio data.

When the reproducing apparatus 200 reproduces the image data and the audio data, a parameter corresponding to an image of each frame is obtained from the parameter file and the parameter is used to perform image processing on the image of the frame. As a result, calculating of parameters may be omitted when the image data is reproduced and thus time required to process a moving picture may be reduced and the moving picture may be easily processed.

In the imaging device 104 such as a CCD or a CMOS, a color filter pattern having a cross stripe shape is sometimes formed on every pixel in order to capture a color image. A typical recording apparatus generates a luminance signal and a chrominance signal by performing predetermine image processing on the color filter pattern, and records an image by compressing the luminance and chrominance signals. Then, when the image is reproduced, the image is displayed on a display device such as a monitor by decompressing recorded and compressed image data and restoring the luminance and chrominance signals.

However, the recording apparatus 100 directly generates the color filter pattern as data, compresses the data, and records the data (raw image data) on the recording medium 152, instead of performing image processing on the color filter pattern. The reproducing apparatus 200 reads image data from the recording medium 152, decompresses the image data, and obtains the color filter pattern. When the image data is reproduced, a luminance signal and a chrominance signal are generated by performing predetermined image processing on the color filter pattern and then an image is displayed on the display 252 such as a monitor, or a display device.

In more detail, since the color filter pattern is directly generated as data (a signal output from the imaging device 104 is directly recorded), quality deterioration of an image may be prevented and the image may be recorded in a high quality. Also, since the reproducing apparatus 200 includes the image signal processor 242, an image may not be processed when a data file is recorded. Thus, a circuit of the recording apparatus 100 may be very simple and power consumption may be reduced.

Also, when the luminance and chrominance signals are generated from the color filter pattern, a white balance correction value and a luminance correction value are calculated from each color filter pattern. Since rapid variations in the white balance correction value and the luminance correction value are not appropriate for AV data, a typical recording apparatus controls white balance correction values and luminance correction values of images to vary smoothly. The typical recording apparatus performs image processing on image data by using the white balance correction values and the luminance correction values, and records the image data on which the image processing is completely performed, on a recording medium. Thus, additional white balance correction or luminance correction cannot be performed on the image data on which the image processing is completely performed.

However, according to the above embodiments of the present invention, the white balance value and the luminance value corresponding to an image of each frame are recorded in a parameter file as data. When the image is reproduced, image processing such as white balance correction or luminance correction is performed by using the white balance value and the luminance value. In this case, image data is recorded in a data file regardless of the white balance value and the luminance value and image quality correction may be controlled by varying the white balance value and the luminance value when the image data is reproduced. The image quality correction may also be controlled by a user. Also, although parameters are re-recorded with predetermined values, the image data is not influenced and may be reproduced in the image quality set by the user, without any problem. In addition to the white balance value and the luminance value, a chromatic aberration of an image may be also corrected after capturing the image.

Furthermore, since image data is reproduced by using a personal computer (PC), a software decoder developed in accordance with technology development may be used and thus the image data may be reproduced in a higher image quality than a hardware decoder that can hardly re-record information. Also, since image processing is performed when the image data is reproduced instead of when the image data is recorded, as an image processing technology such as developing software of raw data progresses, completely recorded image data may be reproduced in a high quality.

In addition, a recorded data file has raw data that is independently recorded regardless of a display device such as a monitor, and may be converted into an arbitrary image signal (National Television System Committee (NTSC)/high definition television (HDTV)) so as to be output, when the data file is reproduced. Also, a color space may be arbitrarily set when the data file is reproduced.

Also, a data file records both image data and audio data in frames and thus the image data and the audio data may be easily synchronized to each other and be easily edited.

While the present invention has been particularly shown and described with reference to exemplary embodiments thereof, it will be understood by those of ordinary skill in the art that various changes in form and details may be made therein without departing from the spirit and scope of the present invention as defined by the claims.

For example, although the image signal compressing unit 108 and the audio signal compressing unit 116 are included in the recording apparatus 100 in FIG. 1, the image signal compressing unit 108 and the audio signal compressing unit 116 may be omitted. In this case, image data and audio data which are not compressed are recorded in a data file, and the image signal decompressing unit 240 and the audio signal decompressing unit 260 of the reproducing apparatus 200 illustrated in FIG. 2 may not respectively decompress the image data and the audio data.

Also, although the reproducing apparatus 200 reads parameters recorded in the recording apparatus 100 and uses the parameters to perform image processing without any change, according to the above embodiments of the present invention, the present invention is not limited thereto. For example, arbitrary parameters which are set by correcting the parameters obtained from the recording apparatus 100 may be used to perform the image processing. Since raw image data is recorded in a data file and parameters are recorded in a parameter file regardless of the data file, a user may easily process a desired image to be reproduced.

Furthermore, although the YC converter 243 is included in the image signal processor 242 of the reproducing apparatus 200 in FIG. 2, the present invention is not limited thereto. For example, the YC converter 243 may be located adjacent to the A/D converter 106 of the recording apparatus 100 so as to perform YC conversion on an image signal, the image signal on which the YC conversion is performed may be compressed by performing reversible compression, and the image signal on which the YC conversion and the reversible compression are performed may be recorded in a data file in frames. In this case, parameters required to perform image processing are calculated in accordance with the image signal on which the YC conversion is performed and a parameter file is generated in accordance with the calculated parameters.

If the data file is generated by using the image signal on which the YC conversion is performed, the reproducing apparatus 200 may not perform the YC conversion. In this case, the image signal processor 242 of the reproducing apparatus 200 obtains the image signal on which the YC conversion is performed, from the data file and performs image processing based on parameters calculated in accordance with the image signal on which the YC conversion is performed.

What is claimed is:

1. A photographing apparatus, comprising:
a recording unit, comprising:
a parameter calculator that receives digital image data output in a sequence of frames from an imaging device and generates at least one parameter for each frame in the sequence of frames, and
a recording medium controller that records a parameter file on a recording medium, the parameter file having the at least one parameter corresponding to each frame in the sequence of frames; and
a reproducing unit, comprising:
a data reader that recovers from the recording medium the parameter file and supplies the parameter file to the parameter file processor,
a parameter file processor that receives the parameter file and reproduces the at least one parameter that corresponds to each frame in the sequence of frames; and
an image processor that performs image processing on digital image data for input to a display in a sequence of frames, wherein the digital image data of each frame in the sequence of frames is processed in accordance with the at least one parameter that corresponds to each frame supplied by the parameter file processor.

2. The photographing apparatus of claim 1, wherein the parameter file processor sets at least one designated value to parameters corresponding to a plurality of frames in a series of desired scenes.

3. A recording apparatus, comprising:
a parameter calculator that receives digital image data output in a sequence of frames from an imaging device and generates at least one parameter for each frame in the sequence of frames; and
a recording medium controller that records a parameter file on a recording medium, the parameter file having the at least one parameter corresponding to each frame in the sequence of frames.

4. A recording apparatus, comprising:
a means for calculating at least one parameter for each frame in a sequence of frames of digital image data output by an imaging device; and
a means for recording a parameter file on a recording medium, the parameter file having the at least one parameter corresponding to each frame in the sequence of frames.

5. A reproducing apparatus comprising:
a parameter file processor that receives a parameter file generated and stored prior to reproduction and reproduces at least one parameter that corresponds to each frame in a sequence of frames of digital image data; and
an image processor that performs image processing on the digital image data before input to a display, wherein the digital image data of each frame in the sequence of frames is processed in accordance with the at least one parameter that corresponds to each frame supplied by the parameter file processor.

6. The reproducing apparatus of claim 5, wherein the parameter file processor sets at least one designated value to parameters corresponding to a plurality of frames in a series of desired scenes.

7. A photographing method comprising steps of:
receiving digital image data output in a sequence of frames from an imaging device;
calculating at least one parameter for each frame in the sequence of frames;
recording the digital image data on a recording medium and recording the at least one parameter corresponding to each frame on the recording medium in a parameter file;
reading the digital image data and the parameter file recorded on the recording medium;
obtaining the at least one parameter required to sequentially reproduce the digital image data in each frame from the parameter file; and
performing image processing on the digital image data of each frame in accordance with the at least one parameter corresponding to each frame.

8. The photographing method of claim 7, further comprising setting at least one designated value to parameters corresponding to a plurality of frames in a series of desired scenes before performing the image processing.
